(19) United States
(12) Patent Application Publication
(10) Pub. No.: US 2009/0150507 A1
(43) Pub. Date: Jun. 11, 2009

(54) SYSTEM AND METHOD FOR PRIORITIZING DELIVERY OF COMMUNICATIONS VIA DIFFERENT COMMUNICATION CHANNELS

(75) Inventors: Marc Eliot Davis, San Francisco, CA (US); Bradley Joseph Horowitz, Oakland, CA (US); Marco Boerries, Los Altos Hills, CA (US); Christopher William Higgins, Portland, OR (US); Joseph James O'Sullivan, Oakland, CA (US); Ronald Martinez, San Francisco, CA (US); Robert Carter Trout, Burlingame, CA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/952,875

(22) Filed: Dec. 7, 2007

(51) Int. Cl. G06F 15/16

(52) U.S. Cl. 709/207

(57) ABSTRACT

The disclosure describes systems and methods for prioritizing delivery of a communication to a recipient via a first communication channel, such as email, voice, voicemail, IM, SMS, or even physical parcel. Prioritization is done by dynamically identifying one or more relationships between the recipient and information known about the communication, the relationships determined from social, spatial, temporal, and logical data previously collected by the system from prior communications on any communication channel. Based on the identified relationships, a priority score is generated for the communication and the communication is delivered to the recipient via one of a plurality of delivery modes based on the priority score.

### BACKGROUND

A great deal of information is generated when people use electronic devices, such as when people use mobile phones and cable set-top boxes. Such information, such as location, applications used, social network, physical and online locations visited, to name a few, could be used to deliver useful services and information to end users, and provide commercial opportunities to advertisers and retailers. However, most of this information is effectively abandoned due to deficiencies in the way such information may be captured. For example, and with respect to a mobile phone, information is generally not gathered while the mobile phone is idle (i.e., not being used by a user). Other information, such as presence of others in the immediate vicinity, time and frequency of messages to other users, and activities of a user's social network are also not captured effectively.

### SUMMARY

This disclosure describes systems and methods for using data collected and stored by multiple devices on a network in order to improve the performance of the services provided via the network. In particular, the disclosure describes systems and methods for prioritizing delivery of a communication to a recipient via a first communication channel, such as email, voice, voicemail, IM, SMS, or even physical parcel. Prioritization is done by dynamically identifying one or more relationships between the recipient and information known about the communication, the relationships determined from social, spatial, temporal, and logical data previously collected by the system from prior communications on any communication channel. Based on the identified relationships, a priority score is generated for the communication and the communication is delivered to the recipient via one of a plurality of delivery modes based on the priority score.

One aspect of the disclosure is a method for delivering messages. The method includes receiving a first message from a sender for delivery to a recipient and retrieving user data associated with the sender and user data associated with the recipient. The method then generates a priority score for the first message based on a comparison of the sender's user data and recipient's user data. The method then displays a message listing to the recipient, such message listing identifying the first message and a plurality of previously-received second messages each having an associated priority score, and wherein the message listing is ordered based on the priority score associated with each message.

Another aspect of the disclosure is a system that prioritizes communications. The system is embodied in one or more computing devices with computer-readable media that operate as a correlation engine, a prioritization engine and a delivery engine. The correlation engine retrieves data associated with information objects (IOs) transmitted between computing devices via at least one communication network. The computer-readable media is connected to the correlation engine and stores at least one of social data, spatial data, temporal data and logical data associated with a plurality of real-world entities (RWEs). The correlation engine, based on the detection of a first communication to be delivered to a first recipient via a first communication network, identifies one or more relationships between the first communication, the first recipient and the plurality of RWEs using the data on the computer-readable medium. The prioritization engine generates a priority score for the communication based on the relationships identified by the correlation engine and the delivery engine delivers the communication to the first recipient based on the priority score.

In yet another aspect, the disclosure describes a computer-readable medium encoding instructions for performing a method for prioritizing delivery of a communication to a recipient via a first communication channel. The encoded method dynamically identifies one or more relationships between the recipient and information known about the communication and, based on the identified relationships, generates a priority score for the communication. The method then delivers the communication to the recipient via one of a plurality of delivery modes based on the priority score. The method may further include retrieving one or more of social data, spatial data, temporal data and logical data associated with the recipient obtained from previous communications associated with the recipient received via a second communication channel and identifying one or more relationships between the recipient and information known about the communication based on the retrieved one or more of social data, spatial data, temporal data and logical data.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 illustrates an example of the relationships between RWEs and IOs on the W4 COMN.

FIG. 2 illustrates an example of metadata defining the relationships between RWEs and IOs on the W4 COMN.

FIG. 3 illustrates a conceptual model of the W4 COMN.

FIG. 4 illustrates the functional layers of the W4 COMN architecture.

FIG. 5 illustrates an embodiment of analysis components of a W4 engine as shown in FIG. 2.

FIG. 6 illustrates an embodiment of a W4 engine showing different components within the sub-engines described generally above with reference to FIG. 5.

FIG. 7 illustrates some of the elements in a W4 engine adapted to prioritize communications based on W4 data.

FIG. 8 illustrates an embodiment of a method for prioritizing the delivery of communications on a network using social, temporal, spatial and topical data for entities on the network.

### DETAILED DESCRIPTION

This disclosure describes a communication network, referred herein as the “W4 Communications Network” or W4 COMN, that uses information related to the “Who, What, When and Where” of interactions with the network to provide improved services to the network's users. The W4 COMN is a collection of users, devices and processes that foster both synchronous and asynchronous communications between users and their proxies. It includes an instrumented network of sensors providing data recognition and collection in real-world environments about any subject, location, user or combination thereof.

As a communication network, the W4 COMN handles the routing/addressing, scheduling, filtering, prioritization, replying, forwarding, storing, deleting, privacy, transacting, triggering of a new message, propagating changes, transcoding and linking. Furthermore, these actions can be performed on any communication channel accessible by the W4 COMN.

The W4 COMN uses a data modeling strategy for creating profiles for not only users and locations but also any device on the network and any kind of user-defined data with user-specified conditions from a rich set of possibilities. Using Social, Spatial, Temporal and Logical data available about a specific user, topic or logical data object, every entity known to the W4 COMN can be mapped and represented against all other known entities and data objects in order to create both a micro graph for every entity as well as a global graph that interrelates all known entities against each other and their attributed relations.

In order to describe the operation of the W4 COMN, two elements upon which the W4 COMN is built must first be introduced, real-world entities and information objects. These distinction are made in order to enable correlations to be made from which relationships between electronic/logical objects and real objects can be determined. A real-world entity (RWE) refers to a person, device, location, or other physical thing known to the W4 COMN. Each RWE known to the W4 COMN is assigned or otherwise provided with a unique W4 identification number that absolutely identifies the RWE within the W4 COMN.

RWEs may interact with the network directly or through proxies, which may themselves be RWEs. Examples of RWEs that interact directly with the W4 COMN include any device such as a sensor, motor, or other piece of hardware that connects to the W4 COMN in order to receive or transmit data or control signals. Because the W4 COMN can be adapted to use any and all types of data communication, the devices that may be RWEs include all devices that can serve as network nodes or generate, request and/or consume data in a networked environment or that can be controlled via the network. Such devices include any kind of “dumb” device purpose-designed to interact with a network (e.g., cell phones, cable television set top boxes, fax machines, telephones, and radio frequency identification (RFID) tags, sensors, etc.). Typically, such devices are primarily hardware and their operations can not be considered separately from the physical device.

Examples of RWEs that must use proxies to interact with W4 COMN network include all non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) are also considered RWEs that must use proxies to interact with the network. Smart devices are electronic devices that can execute software via an internal processor in order to interact with a network. For smart devices, it is actually the executing software application(s) that interact with the W4 COMN and serve as the devices' proxies.

The W4 COMN allows associations between RWEs to be determined and tracked. For example, a given user (an RWE) may be associated with any number and type of other RWEs including other people, cell phones, smart credit cards, personal data assistants, email and other communication service accounts, networked computers, smart appliances, set top boxes and receivers for cable television and other media services, and any other networked device. This association may be made explicitly by the user, such as when the RWE is installed into the W4 COMN. An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association may include the user identifying a specific relationship between the user and the RWE (e.g., this is my device, this is my home appliance, this person is my friend/father/son/etc., this device is shared between me and other users, etc.). RWEs may also be implicitly associated with a user based on a current situation. For example, a weather sensor on the W4 COMN may be implicitly associated with a user based on information indicating that the user lives or is passing near the sensor's location.

An information object (IO), on the other hand, is a logical object that stores, maintains, generates, serves as a source for or otherwise provides data for use by RWEs and/or the W4 COMN. IOs are distinct from RWEs in that IOs represent data, whereas RWEs may create or consume data (often by creating or consuming IOs) during their interaction with the W4 COMN. Examples of IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that may further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In addition, IOs include any executing process or application that consumes or generates data such as an email communication application (such as OUTLOOK by MICROSOFT, or YAHOO! MAIL by YAHOO!), a calendaring application, a word processing application, an image editing application, a media player application, a weather monitoring application, a browser application and a web page server application. Such active IOs may or may not serve as a proxy for one or more RWEs. For example, voice communication software on a smart phone may serve as the proxy for both the smart phone and for the owner of the smart phone.

An IO in the W4 COMN may be provided a unique W4 identification number that absolutely identifies the IO within the W4 COMN. Although data in an IO may be revised by the act of an RWE, the IO remains a passive, logical data representation or data source and, thus, is not an RWE.

For every IO there are at least three classes of associated RWEs. The first is the RWE who owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs who then pay any attention (directly or through a proxy process) to the IO, in which “paying attention” refers to accessing the IO in order to obtain data from the IO for some purpose.

“Available data” and “W4 data” means data that exists in an IO in some form somewhere or data that can be collected as needed from a known IO or RWE such as a deployed sensor. “Sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

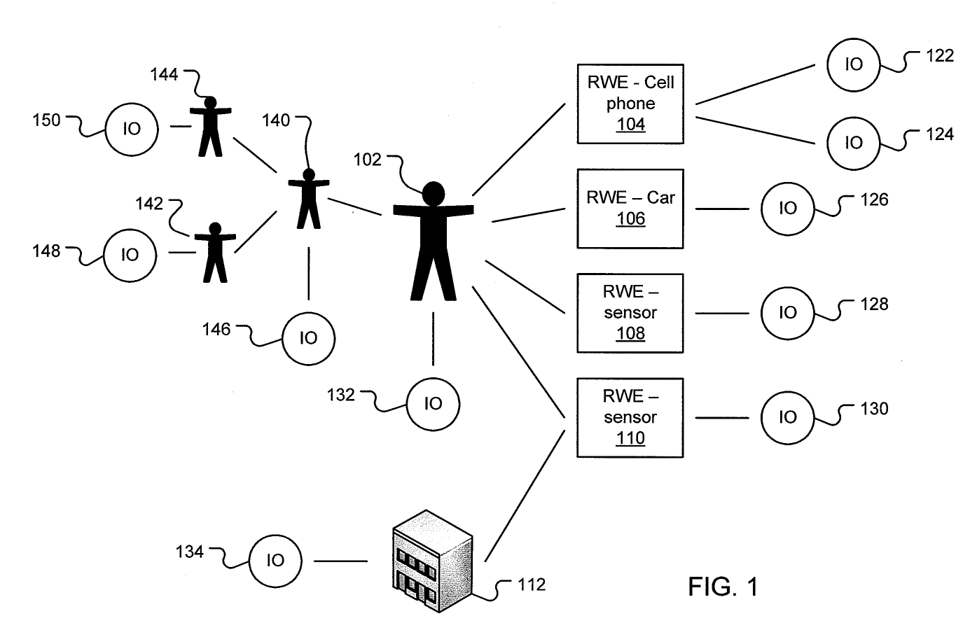

FIG. 1 illustrates an example of the relationships between RWEs and IOs on the W4 COMN. In the embodiment illustrated, a user 102 is a RWE of the network provided with a unique network ID. The user 102 is a human that communicates with the network via the proxy devices 104, 106, 108, 110 associated with the user 102, all of which are RWEs of the network and provided with their own unique network ID. Some of these proxies may communicate directly with the W4 COMN or may communicate with the W4 COMN via IOs such as applications executed on or by the device.

As mentioned above the proxy devices 104, 106, 108, 110 may be explicitly associated with the user 102. For example, one device 104 may be a smart phone connected by a cellular service provider to the network and another device 106 may be a smart vehicle that is connected to the network. Other devices may be implicitly associated with the user 102. For example, one device 108 may be a “dumb” weather sensor at a location matching the current location of the user's cell phone 104, and thus implicitly associated with the user 102 while the two RWEs 104, 108 are co-located. Another implicitly associated device 110 may be a sensor 110 for physical location 112 known to the W4 COMN. The location 112 is known, either explicitly (through a user-designated relationship, e.g., this is my home, place of employment, parent, etc.) or implicitly (the user 102 is often co-located with the RWE 112 as evidenced by data from the sensor 110 at that location 112), to be associated with the first user 102.

The user 102 may also be directly associated with other people, such as the person 140 shown, and then indirectly associated with other people 142, 144 through their associations as shown. Again, such associations may be explicit (e.g., the user 102 may have identified the associated person 140 as his/her father, or may have identified the person 140 as a member of the user's social network) or implicit (e.g., they share the same address).

Tracking the associations between people (and other RWEs as well) allows the creation of the concept of “intimacy”: Intimacy being a measure of the degree of association between two people or RWEs. For example, each degree of removal between RWEs may be considered a lower level of intimacy, and assigned lower intimacy score. Intimacy may be based solely on explicit social data or may be expanded to include all W4 data including spatial data and temporal data.

Each RWE 102, 104, 106, 108, 110, 112, 140, 142, 144 of the W4 COMN may be associated with one or more IOs as shown. Continuing the examples discussed above, FIG. 1 illustrates two IOs 122, 124 as associated with the cell phone device 104. One IO 122 may be a passive data object such as an event record that is used by scheduling/calendaring software on the cell phone, a contact IO used by an address book application, a historical record of a transaction made using the device 104 or a copy of a message sent from the device 104. The other IO 124 may be an active software process or application that serves as the device's proxy to the W4 COMN by transmitting or receiving data via the W4 COMN. Voice communication software, scheduling/calendaring software, an address book application or a text messaging application are all examples of IOs that may communicate with other IOs and RWEs on the network. The IOs 122, 124 may be locally stored on the device 104 or stored remotely on some node or datastore accessible to the W4 COMN, such as a message server or cell phone service datacenter. The IO 126 associated with the vehicle 108 may be an electronic file containing the specifications and/or current status of the vehicle 108, such as make, model, identification number, current location, current speed, current condition, current owner, etc. The IO 128 associated with sensor 108 may identify the current state of the subject(s) monitored by the sensor 108, such as current weather or current traffic. The IO 130 associated with the cell phone 110 may be information in a database identifying recent calls or the amount of charges on the current bill.

Furthermore, those RWEs which can only interact with the W4 COMN through proxies, such as the people 102, 140, 142, 144, computing devices 104, 106 and location 112, may have one or more IOs 132, 134, 146, 148, 150 directly associated with them. An example includes IOs 132, 134 that contain contact and other RWE-specific information. For example, a person's IO 132, 146, 148, 150 may be a user profile containing email addresses, telephone numbers, physical addresses, user preferences, identification of devices and other RWEs associated with the user, records of the user's past interactions with other RWE's on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.). Another example of a person's IO 132, 146, 148, 150 includes remote applications through which a person can communicate with the W4 COMN such as an account with a web-based email service such as Yahoo! Mail. The location's IO 134 may contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In order to correlate RWEs and IOs to identify relationships, the W4 COMN makes extensive use of existing metadata and generates additional metadata where necessary. Metadata is loosely defined as data that describes data. For example, given an IO such as a music file, the core, primary or object data of the music file is the actual music data that is converted by a media player into audio that is heard by the listener. Metadata for the same music file may include data identifying the artist, song, etc., album art, and the format of the music data. This metadata may be stored as part of the music file or in one or more different IOs that are associated with the music file or both. In addition, W4 metadata for the same music file may include the owner of the music file and the rights the owner has in the music file. As another example, if the IO is a picture taken by an electronic camera, the picture may include in addition to the primary image data from which an image may be created on a display, metadata identifying when the picture was taken, where the camera was when the picture was taken, what camera took the picture, who, if anyone, is associated (e.g., designated as the camera's owner) with the camera, and who and what are the subjects of in the picture. The W4 COMN uses all the available metadata in order to identify implicit and explicit associations between entities and data objects.

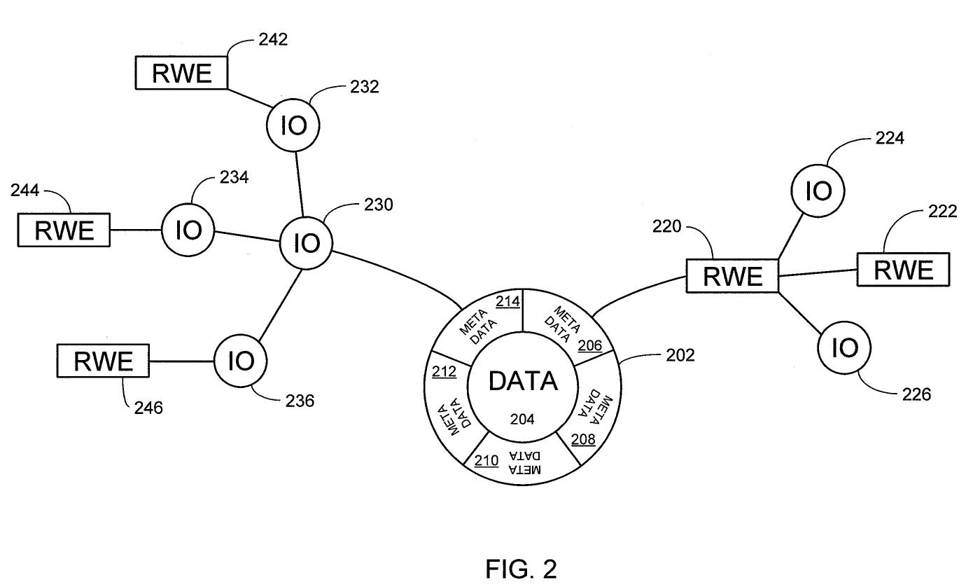

FIG. 2 illustrates an example of metadata defining the relationships between RWEs and IOs on the W4 COMN. In the embodiment shown, an IO 202 includes object data 204 and five discrete items of metadata 206, 208, 210, 212, 214. Some items of metadata 208, 210, 212 may contain information related only to the object data 204 and unrelated to any other IO or RWE. For example, a creation date, text or an image that is to be associated with the object data 204 of the IO 202.

Some of items of metadata 206, 214, on the other hand, may identify relationships between the IO 202 and other RWEs and IOs. As illustrated, the IO 202 is associated by one item of metadata 206 with an RWE 220 that RWE 220 is further associated with two IOs 224, 226 and a second RWE 222 based on some information known to the W4 COMN. This part of FIG. 2, for example, could describe the relations between a picture (IO 202) containing metadata 206 that identifies the electronic camera (the first RWE 220) and the user (the second RWE 224) that is known by the system to be the owner of the camera 220. Such ownership information may be determined, for example, from one or another of the IOs 224, 226 associated with the camera 220.

FIG. 2 also illustrates metadata 214 that associates the IO 202 with another IO 230. This IO 230 is itself associated with three other IOs 232, 234, 236 that are further associated with different RWEs 242, 244, 246. This part of FIG. 2, for example, could describe the relations between a music file (IO 202) containing metadata 206 that identifies the digital rights file (the first IO 230) that defines the scope of the rights of use associated with this music file 202. The other IOs 232, 234, 236 are other music files that are associated with the rights of use and which are currently associated with specific owners (RWEs 242, 244, 246).

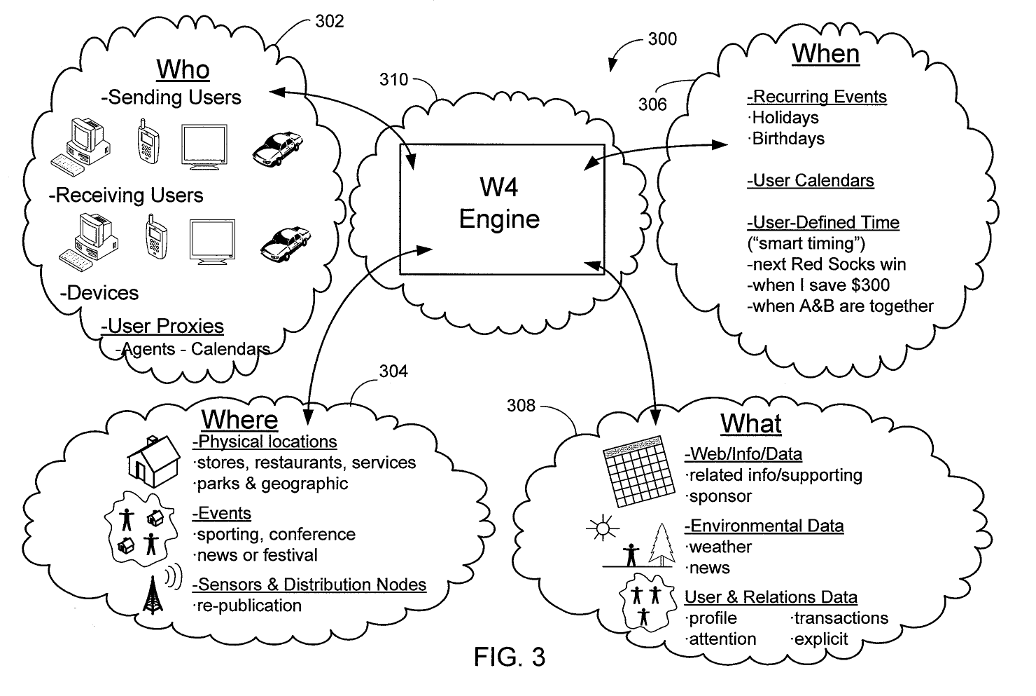

FIG. 3 illustrates a conceptual model of the W4 COMN. The W4 COMN 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc. In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs). The What cloud 308 is comprised of all known data—web or private, commercial or user—accessible to the W4 COMN, including for example environmental data like weather and news, RWE-generated data, IOs and IO data, user data, models, processes and applications. Thus, conceptually, most data is contained in the What cloud 308.

As this is just a conceptual model, it should be noted that some entities, sensors or data will naturally exist in multiple clouds either disparate in time or simultaneously. Additionally, some IOs and RWEs may be composites in that they combine elements from one or more clouds. Such composites may be classified or not as appropriate to facilitate the determination of associations between RWEs and IOs. For example, an event consisting of a location and time could be equally classified within the When cloud 306, the What cloud 308 and/or the Where cloud 304.

The W4 engine 310 is center of the W4 COMN's central intelligence for making all decisions in the W4 COMN. An “engine” as referred to herein is meant to describe a software, hardware or firmware (or combinations thereof) system, process or functionality that performs or facilitates the processes, features and/or functions described herein (with or without human interaction or augmentation). The W4 engine 310 controls all interactions between each layer of the W4 COMN and is responsible for executing any approved user or application objective enabled by W4 COMN operations or interoperating applications. In an embodiment, the W4 COMN is an open platform upon which anyone can write an application. To support this, it includes standard published APIs for requesting (among other things) synchronization, disambiguation, user or topic addressing, access rights, prioritization or other value-based ranking, smart scheduling, automation and topical, social, spatial or temporal alerts.

One function of the W4 COMN is to collect data concerning all communications and interactions conducted via the W4 COMN, which may include storing copies of IOs and information identifying all RWEs and other information related to the IOs (e.g., who, what, when, where information). Other data collected by the W4 COMN may include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

The W4 engine 310 is also responsible for identifying RWEs and relationships between RWEs and IOs from the data and communication streams passing through the W4 COMN. The function of identifying RWEs associated with or implicated by IOs and actions performed by other RWEs is referred to as entity extraction. Entity extraction includes both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object with only W4 metadata related to the object (e.g., date of creation, owner, recipient, transmitting and receiving RWEs, type of IO, etc.), but no knowledge of the internals of the IO (i.e., the actual primary or object data contained within the object). Knowing the content of the IO does not prevent W4 data about the IO (or RWE) to be gathered. The content of the IO if known can also be used in entity extraction, if available, but regardless of the data available entity extraction is performed by the network based on the available data. Likewise, W4 data extracted around the object can be used to imply attributes about the object itself, while in other embodiments, full access to the IO is possible and RWEs can thus also be extracted by analyzing the content of the object, e.g. strings within an email are extracted and associated as RWEs to for use in determining the relationships between the sender, user, topic or other RWE or IO impacted by the object or process.

In an embodiment, the W4 engine 310 represents a group of applications executing on one or more computing devices that are nodes of the W4 COMN. For the purposes of this disclosure, a computing device is a device that includes a processor and memory for storing data and executing software (e.g., applications) that perform the functions described. Computing devices may be provided with operating systems that allow the execution of software applications in order to manipulate data.

In the embodiment shown, the W4 engine 310 may be one or a group of distributed computing devices, such as a general-purpose personal computers (PCs) or purpose built server computers, connected to the W4 COMN by suitable communication hardware and/or software. Such computing devices may be a single device or a group of devices acting together. Computing devices may be provided with any number of program modules and data files stored in a local or remote mass storage device and local memory (e.g., RAM) of the computing device. For example, as mentioned above, a computing device may include an operating system suitable for controlling the operation of a networked computer, such as the WINDOWS XP or WINDOWS SERVER operating systems from MICROSOFT CORPORATION.

Some RWEs may also be computing devices such as smart phones, web-enabled appliances, PCs, laptop computers, and personal data assistants (PDAs). Computing devices may be connected to one or more communications networks such as the Internet, a publicly switched telephone network, a cellular telephone network, a satellite communication network, a wired communication network such as a cable television or private area network. Computing devices may be connected any such network via a wired data connection or wireless connection such as a wi-fi, a WiMAX (802.36), a Bluetooth or a cellular telephone connection.

Local data structures, including discrete IOs, may be stored on a mass storage device (not shown) that is connected to, or part of, any of the computing devices described herein including the W4 engine 310. For example, in an embodiment, the data backbone of the W4 COMN, discussed below, includes multiple mass storage devices that maintain the IOs, metadata and data necessary to determine relationships between RWEs and IOs as described herein. A mass storage device includes some form of computer-readable media and provides non-volatile storage of data and software for retrieval and later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassette, magnetic tape, magnetic disk storage or other magnetic storage devices, or any other medium which can be used to store the desired information and which can be accessed by the computer.

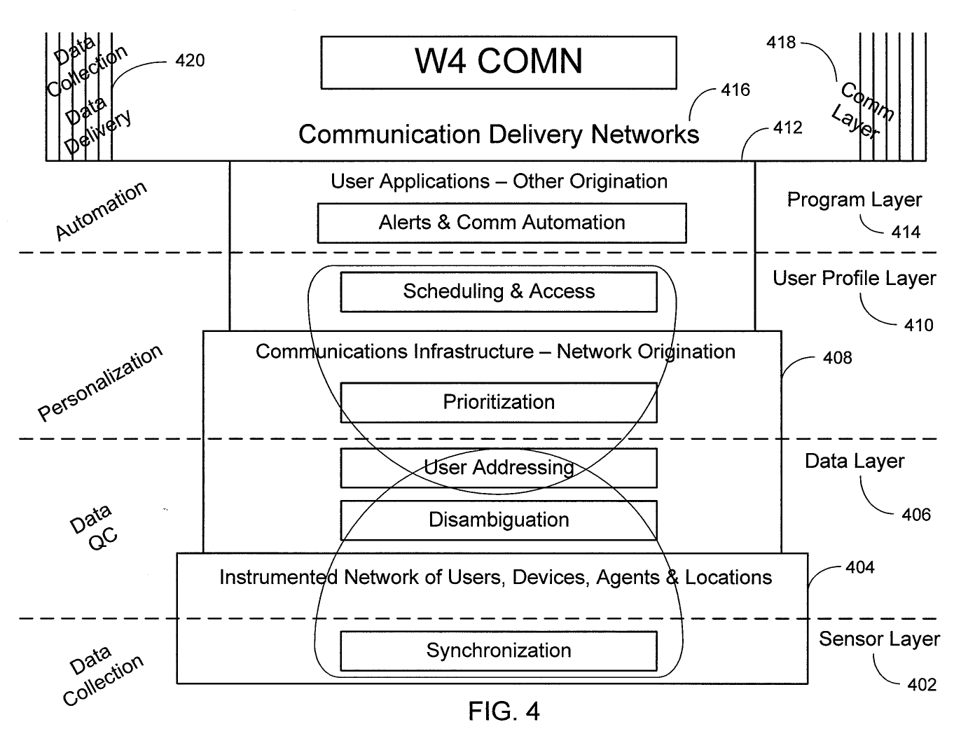

FIG. 4 illustrates the functional layers of the W4 COMN architecture. At the lowest layer, referred to as the sensor layer 402, is the network 404 of the actual devices, users, nodes and other RWEs. The instrumentation of the network nodes to utilize them as sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The next layer is the data layer 406 in which the data produced by the sensor layer 402 is stored and cataloged. The data may be managed by either the network 404 of sensors or the network infrastructure 406 that is built on top of the instrumented network of users, devices, agents, locations, processes and sensors. The network infrastructure 408 is the core under-the-covers network infrastructure that includes the hardware and software necessary to receive that transmit data from the sensors, devices, etc. of the network 404. It further includes the processing and storage capability necessary to meaningfully categorize and track the data created by the network 404.

The next layer of the W4 COMN is the user profiling layer 410. This layer 410 may further be distributed between the network infrastructure 408 and user applications/processes 412 executing on the W4 engine or disparate user computing devices. In the user profiling layer 410 that functions as W4 COMN's user profiling layer 410. Personalization is enabled across any single or combination of communication channels and modes including email, IM, texting (SMS, etc.), photobloging, audio (e.g. telephone call), video (teleconferencing, live broadcast), games, data confidence processes, security, certification or any other W4 COMM process call for available data.

In one embodiment, the user profiling layer 410 is a logic-based layer above all sensors to which sensor data are sent in the rawest form to be mapped and placed into the W4 COMN data backbone 420. The data (collected and refined, related and deduplicated, synchronized and disambiguated) are then stored in one or a collection of related databases available to all processes of all applications approved on the W4 COMN. All Network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from anything other than the network, e.g., RWEs such as users, locations, proxies and processes, come from the applications layer 414 of the W4 COMN. Some applications may be developed by the W4 COMN operator and appear to be implemented as part of the communications infrastructure 408, e.g. email or calendar programs because of how closely the operate with the sensor processing and user profiling layer 410. The applications 412 also serve some role as a sensor in that they, through their actions, generate data back to the data layer 406 via the data backbone concerning any data created or available due to the applications execution.

The applications layer 414 also provides a personalized user interface (UI) based upon device, network, carrier as well as user-selected or security-based customizations. Any UI can operate within the W4 COMN if it is instrumented to provide data on user interactions or actions back to the network. This is a basic sensor function of any W4 COMN application/UI, and although the W4 COMN can interoperate with applications/UIs that are not instrumented, it is only in a delivery capacity and those applications/UIs would not be able to provide any data (let alone the rich data otherwise available from W4-enabled devices.)

In the case of W4 COMN mobile devices, the UI can also be used to confirm or disambiguate incomplete W4 data in real-time, as well as correlation, triangulation and synchronization sensors for other nearby enabled or non-enabled devices. At some point, the network effects of enough enabled devices allow the network to gather complete or nearly complete data (sufficient for profiling and tracking) of a non-enabled device because of it's regular intersection and sensing by enabled devices in it's real-world location.

Above the applications layer 414 (and sometimes hosted within it) is the communications delivery network(s) 416. This can be operated by the W4 COMN operator or be independent third-party carrier service, but in either case it functions to deliver the data via synchronous or asynchronous communication. In every case, the communication delivery network 414 will be sending or receiving data (e.g., http or IP packets) on behalf of a specific application or network infrastructure 408 request.

The communication delivery layer 418 also has elements that act as sensors including W4 entity extraction from phone calls, emails, blogs, etc. as well as specific user commands within the delivery network context, e.g., “save and prioritize this call” said before end of call may trigger a recording of the previous conversation to be saved and for the W4 entities within the conversation to analyzed and increased in weighting prioritization decisions in the personalization/user profiling layer 410.

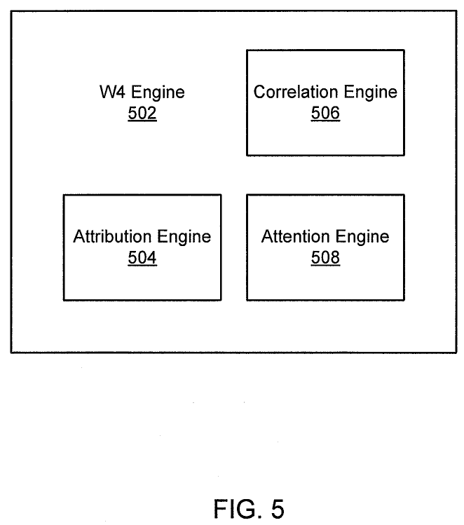

FIG. 5 illustrates an embodiment of analysis components of a W4 engine as shown in FIG. 3. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. One such sub-engine is an attribution engine 504. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the W4 COMN.

The W4 engine 502 further includes a correlation engine 506. The correlation engine 506 operates in two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of the correlation engine 506 is done by graphing the available data. In this embodiment, a histogram of all RWEs and IOs is created, from which correlations based on the graph may be made. Graphing, or the act of creating a histogram, is a computer science method of identify a distribution of data in order to identify relevant information and make correlations between the data. In a more general mathematical sense, a histogram is simply a mapping mᵢ that counts the number of observations that fall into various disjoint categories (known as bins), whereas the graph of a histogram is merely one way to represent a histogram. By selecting each IO, RWE, and other known parameters (e.g., times, dates, locations, etc.) as different bins and mapping the available data, relationships between RWEs, IOs and the other parameters can be identified.

As a pre-processor, the correlation engine 506 monitors the information provided by RWEs in order to determine if any conditions are identified that may trigger an action on the part of the W4 engine 502. For example, if a delivery condition has be associated with a message, when the correlation engine 506 determines that the condition is met, it can transmit the appropriate trigger information to the W4 engine 502 that triggers delivery of the message.

The attention engine 508 instruments all appropriate network nodes, clouds, users, applications or any combination thereof and includes close interaction with both the correlation engine 506 and the attribution engine 504.

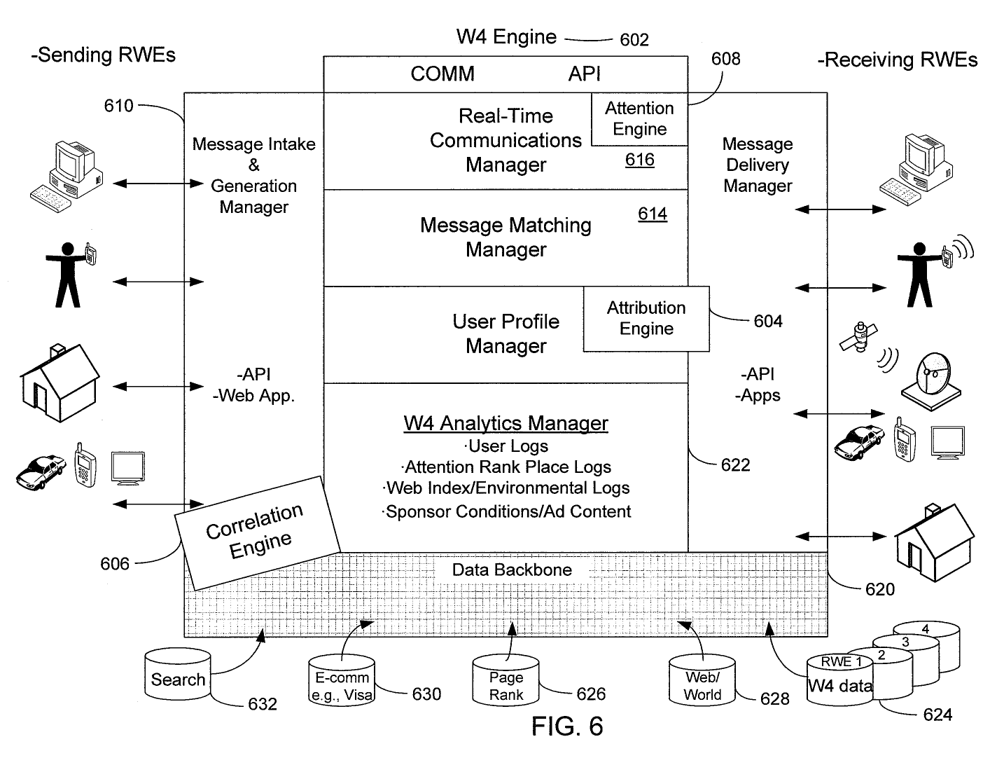

FIG. 6 illustrates an embodiment of a W4 engine showing different components within the sub-engines described generally above with reference to FIG. 4. In one embodiment the W4 engine 600 includes an attention engine 608, attribution engine 604 and correlation engine 606 with several sub-managers based upon basic function.

The attention engine 608 includes a message intake and generation manager 610 as well as a message delivery manager 612 that work closely with both a message matching manager 614 and a real-time communications manager 616 to deliver and instrument all communications across the W4 COMN.

The attribution engine 604 works within the user profile manager 618 and in conjunction with all other modules to identify, process/verify and represent ownership and rights information related to RWEs, IOs and combinations thereof.

The correlation engine 606 dumps data from both of its channels (sensors and processes) into the same data backbone 620 which is organized and controlled by the W4 analytics manager 622 and includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any W4COMN process, IO or event. Because of the amount of data that the W4 COMN will potentially store, the data backbone 620 includes numerous database servers and datastores in communication with the W4 COMN to provide sufficient storage capacity.

As discussed above, the data collected by the W4 COMN includes spatial data, temporal data, RWE interaction data, IO content data (e.g., media data), and user data including explicitly-provided and deduced social and relationship data. Spatial data may be any data identifying a location associated with an RWE. For example, the spatial data may include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data may be passively collected time data (e.g., time data from a clock resident on the electronic device, or time data from a network clock), or the temporal data may be actively collected time data, such as time data entered by the user of the electronic device (e.g., a user maintained calendar).

The interaction data may be any data associated with user interaction of the electronic device, whether active or passive. Examples of interaction data include interpersonal communication data, media data, relationship data, transactional data and device interaction data, all of which are described in further detail below. Table 1, below, is a non-exhaustive list including examples of electronic data.

TABLE 1
Examples of Electronic Data

| Spatial Data | Temporal Data | Interaction Data |
|---|---|---|
| Cell tower data | Time stamps | Interpersonal |
| GPRS data | Local clock | communication data |
| GPS data | Network clock | Media data |
| WiFi data | User input of | Relationship data |
| Personal area network data | time data | Transactional data |
| Network access points data | | Device interaction data |
| User input of location data | | |
| Geo-coordinates data | | |

With respect to the interaction data, communications between any RWEs may generate communication data that is transferred via the W4 COMN. For example, the communication data may be any data associated with an incoming or outgoing short message service (SMS) message, email message, voice call (e.g., a cell phone call, a voice over IP call), or other type of interpersonal communication relative to an RWE, such as information regarding who is sending and receiving the communication(s). As described above, communication data may be correlated with, for example, temporal data to deduce information regarding frequency of communications, including concentrated communication patterns, which may indicate user activity information.

Logical and IO data refers to the data contained by an IO as well as data associated with the IO such as creation time, owner, associated RWEs, when the IO was last accessed, etc. If the IO is a media object, the term media data may be used. Media data may include any data relating to presentable media, such as audio data, visual data, and audiovisual data. For example, the audio data may be data relating to downloaded music, such as genre, artist, album and the like, and includes data regarding ringtones, ringbacks, media purchased, playlists, and media shared, to name a few. The visual data may be data relating to images and/or text received by the electronic device (e.g., via the Internet or other network). The visual data may be data relating to images and/or text sent from and/or captured at the electronic device. The audiovisual data may be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data may include data relating to the user's RSS feeds, subscriptions, group memberships, game services, alerts, and the like. The media data also includes non-network activity, such as image capture and/or video capture using an electronic device, such as a mobile phone. The image data may include metadata added by the user, or other data associated with the image, such as, with respect to photos, location when the photos were taken, direction of the shot, content of the shot, and time of day, to name a few. As described in further detail below, media data may be used, for example, to deduce activities information or preferences information, such as cultural and/or buying preferences information.

The relationship data may include data relating to the relationships of an RWE or IO to another RWE or IO. For example, the relationship data may include user identity data, such as gender, age, race, name, social security number, photographs and other information associated with the user's identity. User identity information may also include e-mail addresses, login names and passwords. Relationship data may further include data identifying explicitly associated RWEs. For example, relationship data for a cell phone may indicate the user that owns the cell phone and the company that provides the service to the phone. As another example, relationship data for a smart car may identify the owner, a credit card associated with the owner for payment of electronic tolls, those users permitted to drive the car and the service station for the car.

Relationship data may also include social network data. Social network data includes data relating to any relationship that is explicitly defined by a user or other RWE, such as data relating to a user's friends, family, co-workers, business relations, and the like. Social network data may include, for example, data corresponding with a user-maintained electronic address book. Relationship data may be correlated with, for example, location data to deduce social network information, such as primary relationships (e.g., user-spouse, user-children and user-parent relationships) or other relationships (e.g., user-friends, user-co-worker, user-business associate relationships). Relationship data also may be utilized to deduce, for example, activities information.

The interaction data may also include transactional data. The transactional data may be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data may be utilized, for example, to deduce activities and preferences information. The transactional information may also be used to deduce types of devices and/or services the user owns and/or in which the user may have an interest.

The interaction data may also include device or other RWE interaction data. Such data includes both data generated by interactions between a user and a RWE on the W4 COMN and interactions between the RWE and the W4 COMN. RWE interaction data may be any data relating to an RWE's interaction with the electronic device not included in any of the above categories, such as habitual patterns associated with use of an electronic device data of other modules/applications, such as data regarding which applications are used on an electronic device and how often and when those applications are used. As described in further detail below, device interaction data may be correlated with other data to deduce information regarding user activities and patterns associated therewith. Table 2, below, is a non-exhaustive list including examples of interaction data.

TABLE 2
Examples of Interaction Data

| Type of Data | Example(s) |
|---|---|
| Interpersonal | Text-based communications, such as SMS |
| communication data | and e-mail |
| | Audio-based communications, such as voice |
| | calls, voice notes, voice mail |
| | Media-based communications, such as |
| | multimedia messaging service (MMS) |
| | communications |
| | Unique identifiers associated with a |
| | communication, such as phone numbers, e- |
| | mail addresses, and network addresses |
| Media data | Audio data, such as music data (artist, genre, |
| | track, album, etc.) |
| | Visual data, such as any text, images and |
| | video data, including Internet data, picture |
| | data, podcast data and playlist data |
| | Network interaction data, such as click |
| | patterns and channel viewing patterns |
| Relationship data | User identifying information, such as name, |
| | age, gender, race, and social security number |
| | Social network data |
| Transactional data | Vendors |
| | Financial accounts, such as credit cards and |
| | banks data |
| | Type of merchandise/services purchased |
| | Cost of purchases |
| | Inventory of purchases |
| Device interaction data | Any data not captured above dealing with |
| | user interaction of the device, such as |
| | patterns of use of the device, applications |
| | utilized, and so forth |

### Communication Prioritization

One notable aspect of the W4 COMN is the ability to prioritize the delivery of individual messages or communications from the different communication channels handled by the W4 COMN. Prioritization is a personal information management (PIM) function that personalizes and automates the sorting, filtering and processing of communications on different channels of the W4 COMN, which may include text, email, IM, telephone, VoIP, video or other multimedia communications delivered or requested to be delivered. Prioritization is done by using a value-based ranking to score all incoming communications based upon a W4 entity analysis of the communication, it's sender, topic, path or other attribute useful for classifying and matching the communication to an automated response or action. Prioritization may be performed both on personal communications (text, email, telephone, etc.) as well as purely programmatic communications between different software applications executing on RWEs on the network. Prioritization may provide differentiated service to software application requests across the network in order to automatically privilege certain applications or request types/contents in W4 COMN operations.

The value-based ranking used to prioritize communications is determined based on the relationships between the sending and receiving RWEs, which are themselves determined from an analysis of the W4 data for the RWEs. This leverages knowledge of the social or organizational status of RWEs related to the communication to flag and prioritize email responses. W4 Prioritization is a value-based ranking implementation that produces importance ordering of communications based upon importance, urgency and interestingness as well as other factors to create a dynamic ranking of every communication in every channel that is used to preference User interactions. For example, communications with a score above a certain threshold (based upon W4 data analysis) may be put through to a user immediately, while communications beneath a different threshold may be filtered out as spam and never delivered to a user.

As discussed in greater detail below, the value-based ranking is determined by mapping all communications to a social relationship graph and dynamically over time prioritizing the communications in each channel, e.g., in a user's inbox based upon the user's relationships and interactions with prior messages from or to the sender, the topic of the communication (if known), a location of either the sender or recipient, or time to create a personalized re-ranking of messages within and/or between communication channels.

Prioritizations (i.e., the value of the rank) can be explicitly entered or overridden by a sending RWE. In addition, such prioritizations can also be initially seeded and augmented over time by the identification of relationships between RWEs with respect to specific communications formats or channels in order to optimize the prioritization process over time based upon user actions and feedback. From these models an ordered list of RWEs and their relationships can be created, so that any new incoming message is compared against this list for immediate prioritization.

In addition to prioritizing the queues of various communication channels, the W4 prioritization process can also return expected or suggested response times based upon the ranking for the specific combination of message type, message content and sender/recipient data. Thus, the W4 prioritization can be considered an importance-ordered system of delivering communications instead of a time-ordered system in common use today.

For the purposes of this description, communication refers to any message of any format that is to be delivered from one RWE to another via the W4 COMN. Thus, a communication includes an email message from one email account to another, a voicemail message left for a computing device such as cell phone, an IM transmitted to a cell phone or computing device, or a packet of data transmitted from one software application to another on a different device. A communication will normally take the form of an IO that is created by one RWE and transmitted to another over the W4 COMN. A communication may also be a stream of data, delivery then being the opening of the connection with the recipient RWE so that the stream is received.

Delivery refers to the delivery of the actual data, e.g., the email message data, to the target recipient. In addition, delivery also refers to the act of notifying the target recipient RWE of the existence of the communication. For example, delivery refers to the situation in which an email account shows that an email has been received in the account's inbox, even though the actual contents of the message have not been received, as occurs when the message is retrieved from a remote location only when it is opened by the account owner. Likewise, delivery also refers to the notification of a cell phone that a voicemail has been received, even though the data of the voicemail is retained at a remote location.

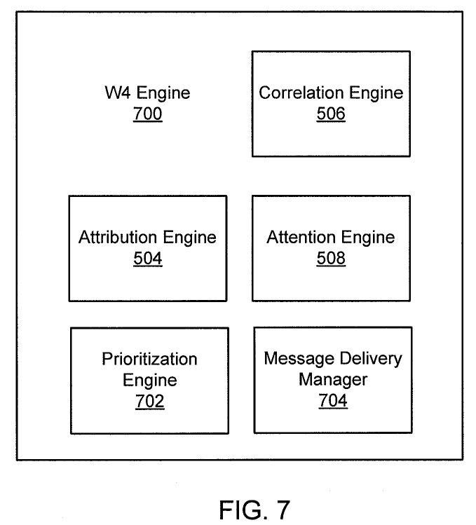

FIG. 7 illustrates some of the elements in a W4 engine adapted to perform W4 prioritization as described herein. The W4 engine 700 includes a correlation engine 506, an attribution engine 504 and an attention engine 508 as described above. In addition, the W4 engine includes a prioritization engine 702 that, based on the relationships between IOs and RWEs determined by the correlation engine 506 as described below and generates a prioritization rank, or priority score, for the communication. The communication is then delivered by the message delivery manager 704 which schedules and delivers the communication based on the priority score. Depending on the embodiment, the prioritization engine 702 may provide directions to the message delivery manager 704 on when/how to deliver a message or, alternatively, the prioritization engine 702 may only provide the message delivery manager 704 the priority score for the message from which the manager 704 determines when/how the message is to be delivered. As discussed above with reference to the W4 engine, the W4 engine and its various components (hardware, software and/or firmware) and sub-engines could be implemented on a server computer or other suitable computing device or distributed across a number of computing devices.

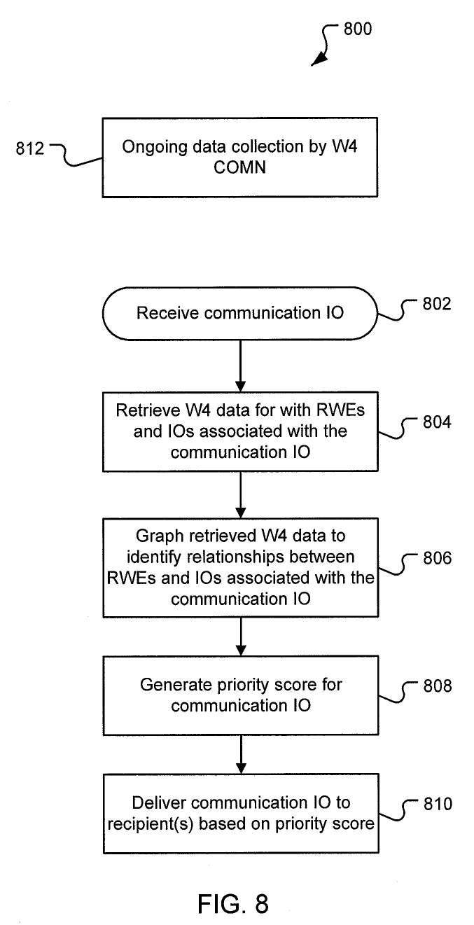

FIG. 8 illustrates an embodiment of a method for prioritizing the delivery of communications on a network using social, temporal, spatial and topical data for entities on the network. In the embodiment described below, depending on how the architecture is implemented the operations described may be performed by one or more of the various engines described above. In addition, sub-engines may be created and used to perform specific operations in order to improve the network's performance as necessary.

As described above, a foundational aspect of the W4 COMN that allows for prioritization is the ongoing collection and maintenance of W4 data from the RWEs interacting with the network. In an embodiment, this collection and maintenance is an independent operation 812 of the W4 COMN and thus current W4 social, temporal, spatial and topical data are always available for use in prioritization. In addition, part of this data collection operation 812 includes the determination of ownership and the association of different RWEs with different IOs as described above. Therefore, each IO is owned/controlled by at least one RWE with a known, unique identifier on the W4 COMN and each IO may have many other associations with other RWEs that are known to the W4 COMN.

In the embodiment shown, the method 800 is initiated when an IO that is to be communicated to some recipient (which may be an RWE or another IO) is received by the W4 COMN in a receive communication operation 802. The receive communication operation 802 may include receiving an actual IO from an RWE such as a sensor or IO such as a program being executed by an RWE. In addition, the receive communication operation 802 also includes situations in which the W4 COMN is alerted that there is a communication IO to be delivered but in which the IO is not actually received by the W4 COMN until a connection is opened with the recipient or some other handshake between systems or condition occurs.

The communication IO received will include information identifying at least the recipient or recipients of the IO and typically will include an identification of sender. Note that the attribution engine may be called on to identify the sender of an IO in the event that the information is not contained or already provided with the IO. In an embodiment, the sender and recipients may be identified by a communication channel-specific identifier (e.g., an email address for email messages, a telephone number for telephone calls or text messages over a cellular network, etc.). From these channel-specific identifiers the W4 COMN can determine the unique W4 identifier for the various parties and, therefore, identify all W4 data stored by the system, regardless of the source of the information, for each of the parties. In an embodiment, a communication IO may also include one or more a unique W4 identifiers for IO or RWEs related communication IO (e.g., as sender, recipient, topic, etc.) which may obviate the need to correlate a channel-specific identifier with a unique W4 identifier.

The receive communication operation 802 may also include identifying additional information about the communications such as the topic of the communication, when and where the communication was created, and identification other RWEs referred to in the communication (e.g., people listed in an email chain but that are neither a sender nor recipient of the current email) or other IOs (e.g., hyperlinks to IOs, etc.) related to the communication.

The communication IO may or may not be provided with prioritization information, such as user/RWE-selected priority ranking or some other information intended to the affect the prioritization of the communication. For example, in some email applications it is possible to flag an email with a visual indicator identifying an email as being relatively more or less important. In current systems, this results in the visual indicator being displayed to the recipient in association with the email, but has no effect on when the email is actually delivered to the recipient's email application. In an embodiment, such a visual indicator may be considered by the W4 prioritization engine as sender-provided information intended to affect the priority and delivery of the communication. Such sender-provided information may then be used as an addition factor that modifies the relative priority score as described below. Another example of sender-provided information that may used in prioritizing a communication is whether the recipient is a carbon copy (cc) recipient.

The receive communication operation 802 may occur at any point in the delivery chain within the W4 COMN, e.g., by any one of the engines used to conduct the communication intake, communication routing or delivery. For example, depending on how the W4 COMN operators choose to implement the network functions, a communication may be prioritized by any one of the message intake and generation manager, user profile manager, message delivery manager or any other engine or manager in the W4 COMN's communication delivery chain.

In response to receiving a communication, a data retrieval operation 804 is performed. In the data retrieval operation 804, data associated with the sender, recipient(s) and any other RWEs or IOs related to the communication are retrieved. In an embodiment, the data retrieval operation 804 further includes retrieval of additional W4 data up to all of the W4 data stored in order to perform the graphing operation 806 described below. The amount and extent of available data that is retrieved may be limited by filtering which the RWE's and IO's data are retrieved. Such W4 data retrieved may include social data, spatial data, temporal data and logical data associated with each RWE. As discussed above, such W4 data may have been collected from communications and IOs obtained by the W4 COMN via many different communication channels and systems.

For example, an email message may be transmitted from a known sender to multiple recipients and the address of one of the recipients may be a non-unique identifier. Because the owner and the other recipients can be resolved to existing RWEs using information known to the email communication network, the unique W4 identifier for those RWEs may be determined. Using the unique W4 identifier, then, the W4 COMN can identify and retrieve all W4 data associated with those users, including information obtained from other communication channels. Thus, such W4 data as time and location data obtained from cellular telephone communications for each of the sender and recipient RWEs, social network information for each of the sender and recipient RWEs (e.g., who are listed as friends, co-workers, etc. for each of the sender and recipient RWEs on social network sites), and what topics have been discussed when in previous communications by each of the sender and recipient RWEs.

In addition, the W4 data related to all RWEs known may, in whole or in part, be retrieved. In this embodiment, the non-unique identifier is considered to potentially be associated with any RWE known to the system. If a preliminary filtering is possible, the RWEs for which W4 data are retrieved may be limited based on a preliminary set of factors.

The method 800 graphs the retrieved W4 data in a graphing operation 806. In the graphing operation 806, correlations are made between each of the recipient and sender RWEs based on the social data, spatial data, temporal data and logical data associated with each RWE. In one sense, the graphing operation 806 may be considered a form of comparing the retrieved social data, spatial data, temporal data and logical data for each RWE with the retrieved data associated with the communication IO and the information contained in the communication IO.

Based on the results of the graphing operation 806, a priority score is generated in a priority score generation operation 808. A priority score is a value representing the relative priority of the communication to the recipient of the communication. For each recipient known to the system a priority score may be generated. The priority score generated may take into account the relative priority of the message and its topic to both the sender and the recipient of the communication. The priority score generated may take into account such W4 information known to the W4 COMN and allows the probability to reflect W4 data received from different communication channels and associated with the different parties.

In an embodiment, the generation operation 808 independently generates a different priority score for the communication IO for each recipient of the communication if there is more than one. Each priority score is determined based on the relationships between that recipient and the sender and communication as determined based on their W4 data. As the relationships are likely to differ between parties, the same communication may be provided a different priority score for each recipient.

In an embodiment, the probability operation 808 takes into account information contained within the communication in that the priority score generated for each recipient will indicate a higher priority if the results of the graphing operation 806 show that the recipient has a strong relationship with the topic. The strength of a relationship with a topic may be determined by identifying how many previous communications or IOs having the same topic are associated with the recipient (either as a sender, recipient, creator, etc.) or even associated with other RWEs that are themselves associated with the recipient. For example, if the topic of the communication is person and the recipient has a strong relationship to that person (e.g., as indicated from previous communications with or about that person or based on information, such as social network information, that identifies some important social relationship with that person), then the priority score will be greater than that generated for a communication about a person to which the recipient has no known relationship.

In an embodiment, the value of the priority score for a communication to a recipient may also be determined in part based on the relationship between the sender of the communication and the recipient. This determination includes determining a relationship between the sender and the recipient based on the retrieved social data, spatial data, temporal data and logical data for each. This relationship may be implicit and determined as a result of the correlations identified during the graphing operation 806. Alternatively, the relationships may be explicit and simply retrieved as part of the data retrieval operation 804.

In yet another embodiment, the value of the priority score may also reflect the importance of the topic to the sender. Such may be determined based on sender-provided priority information (e.g., a selection of a high importance status by the sender when sending the communication) or, alternatively, by determining the relationship of the topic of the communication with the sender. If the topic is determined to be highly important to the sender, then the priority score of the communication may be relatively higher than a communication which does not have a strong relationship with the sender.

Another factor in the generation of a priority score is a temporal factor as determined by analysis of the temporal data associated with the communication. For example, if the topic of the communication is an upcoming meeting, then the priority score of the communication may reflect how close the time of the upcoming meeting is to the current time. If the meeting is months away, the priority score may be unaffected by the temporal data. However, if the meeting is hours away, then a relatively higher priority score may be generated for the communication.

Yet another factor may be spatial. For example, if the topic of the communication has a spatial component, e.g., the communication is about a specific restaurant, the priority score generated for the communication may differ depending on the relative proximity of the recipient to the restaurant, as indicated by W4 data identifying the current or recent location of the recipient. Such information may be determined, for example, from information obtained from a sensor or cell phone associated with the recipient.

The various relationships identified between the topic data, the temporal data, spatial data, and the sender and recipients of the communication may not be treated equally. In order to obtain more accurate results, different relationships and different types (social, spatial, topical, temporal, etc.) of relationships may be assigned different weights when generating a priority score. For example, relationships based on spatial and temporal correlations may be assigned a greater relative weight than relationships based solely on social relationships. Likewise, relationships based on the relative frequency and topic of communications between two parties may be assigned a weight different from that accorded to a explicit designation that the two parties are friends, family members, etc. Thus, relationships could be determined by comparing current contact attributes of the sender and the recipient, by comparing spatial data for each of the sender and recipient, by comparing past contact attributes of the sender and recipient, by retrieving at least one relationship previously selected by one of the sender or recipient, and/or by identifying previous messages between the sender and recipient.

When generating a priority score for the communication, the priority score may be created by aggregating priority scores or weighted values assigned to the different relationships between the recipient and the other identifiable RWEs, topics, etc. of the communication. For example, a priority score may be an aggregation of a priority score of the sender to the recipient, of the topic to the recipient (or other recipients), of the recipient to the other recipients, and/or of the topic to the sender. Thus, it is possible for a communication to one recipient to be given a high priority score because its topic has a strong relationship to another person with whom the recipient has a strong relationship.

The correlation and comparison process of the generate priority score operation 808 can determine relationships between parties, topics, locations, etc. in part though the W4 COMN's identification of each RWE by a unique identifier and storage of information about the past interactions by those RWEs. The actual values obtained as priority scores by the generation operation 808 may vary depending on the calculations performed and weighting factors used. Any suitable method or algorithm for generating a value from different relationships identified in the data may be used. For example, all probabilities may be normalized to some scale or may be aggregated without normalization.

In an embodiment, the W4 data are processed and analyzed using data models that treat data not as abstract signals stored in databases, but rather as IOs that represent RWEs that actually exist, have existed, or will exist in real space, real time, and are real people, objects, places, times, and/or events. As such, the data model for W4 IOs that represent W4 RWEs (Where/When/Who/What) will model not only the signals recorded from the RWEs or about the RWEs, but also represent these RWEs and their interactions in ways that model the affordances and constraints of entities and activities in the physical world. A notable aspect is the modeling of data about RWEs as embodied and situated in real world contexts so that the computation of similarity, clustering, distance, and inference take into account the states and actions of RWEs in the real world and the contexts and patterns of these states and actions.

For example, for temporal data the computation of temporal distance and similarity in a W4 data model cannot merely treat time as a linear function. The temporal distance and similarity between two times is dependent not only on the absolute linear temporal delta between them (e.g., the number of hours between “Tuesday, November 20, 4:00 pm Pacific Time” and “Tuesday, November 20, 7:00 pm Pacific Time”), but even more so is dependent on the context and activities that condition the significance of these times in the physical world and the other W4 RWEs (people, places, objects, and events) etc.) associated with them. For example, in terms of distance and similarity, “Tuesday, November 20, 4:00 pm Pacific Time” and “Tuesday, November 27, 4:00 pm Pacific Time” may be modeled as closer together in a W4 temporal data model than “Tuesday, November 20, 4:00 pm Pacific Time” and “Tuesday, November 20, 7:00 pm Pacific Time” because of the weekly meeting that happens every Tuesday at work at 4:00 pm vs. the dinner at home with family that happens at 7 pm on Tuesdays. Contextual and periodic patterns in time may be important to the modeling of temporal data in a W4 data model.

An even simpler temporal data modeling issue is to model the various periodic patterns of daily life such as day and night (and subperiods within them such as morning, noon, afternoon, evening, etc.) and the distinction between the workweek and the weekend. In addition, salient periods such as seasons of the year and salient events such as holidays also affect the modeling of temporal data to determine similarity and distance. Furthermore, the modeling of temporal data for IOs that represent RWEs should correlate temporal, spatial, and weather data to account for the physical condition of times at different points on the planet. Different latitudes have different amounts of daylight and even are opposite between the northern and southern hemispheres. Similar contextual and structural data modeling issues arise in modeling data from and about the RWEs for people, groups of people, objects, places, and events.

With appropriate data models for IOs that represent data from or about RWEs, a variety of machine learning techniques can be applied to analyze the W4 data. In an embodiment, W4 data may modeled as a “feature vector” in which the vector includes not only raw sensed data from or about W4 RWEs, but also higher order features that account for the contextual and periodic patterns of the states and action of W4 RWEs. Each of these features in the feature vector may have a numeric or symbolic value that can be compared for similarity to other numeric or symbolic values in a feature space. Each feature may also be modeled with an additional value from 0 to 1 (a certainty value) to represent the probability that the feature is true. By modeling W4 data about RWEs in ways that account for the affordances and constraints of their context and patterns in the physical world in features and higher order features with or without certainty values, this data (whether represented in feature vectors or by other data modeling techniques) can then be processed to determine similarity, difference, clustering, hierarchical and graph relationships, as well as inferential relationships among the features and feature vectors.

A wide variety of statistical and machine learning techniques can be applied to W4 data from simple histograms to Sparse Factor Analysis (SFA), Hidden Markov Models (HMMs), Support Vector Machines (SVMs), Bayesian Methods, etc. Such learning algorithms may be populated with data models that contain features and higher order features represent not just the “content” of the signals stored as IOs, e.g., the raw W4 data, but also model the contexts and patterns of the RWEs that exist, have existed, or will exist in the physical world from which these data have been captured.

For example, consider an email on a construction project sent to the project manager of the project and that carbon copies an administrator. The topic of the email is determined from the content of the email, e.g., such as by a text and keyword analysis, and by graphing the W4 data the relationship between the topic (the construction project) and the project manager and between the topic and the administrator can be determined. If, for example, the project manager responds to 85% of the emails received on this topic and responds, on average, within 8 hours, that information may be used to determine that the project manager has a strong relationship with the topic and, thus, that the communication to the manager should be assigned a relatively higher priority score that that assigned to email to which the project manager has no relationship. Furthermore, if the administrator, on the other hand, rarely responds to the emails and when the administrator has responded did so, on average, within 3 days, this information may be to determine that the administrator does not have a high priority relationship with the topic. Thus, the same communication may not be delivered to the administrator at the same time or in the same way that the communication is delivered to the project manager.

After the priority score(s) has been generated from the graphed W4 data, the method 800 then delivers the communication IO to the recipient in accordance with the priority score in a delivery operation 810. As discussed above, delivery may be actual delivery of the communication IO or a notification that the IO is available for retrieval.

The priority score may cause the W4 COMN to deliver the communication IO via one or more different delivery ways or modes. By delivery mode it is meant different ways of delivering the communication including ways of displaying the communication information, ways of notifying the recipient of the communication, and channels of delivering the communication or information related thereto. In an embodiment, only one delivery mode will correspond to how the delivery would be performed in the absence of the W4 prioritization of the communication, i.e., how the communication channel would handle the communication based on its attributes. Thus, by delivering the communication based on its priority score, the W4 COMN is selecting one or more of a set of delivery modes for delivery of the communication; that selection being in addition to any operation performed by the communication channel handling the communication.

In order to override how the communication channel would normally deliver a given communication (i.e., the normal delivery mode), one or more attributes of the communication may be modified. For example, the priority score may be appended to a communication or the format of the communication may be changed, thereby changing the delivery mode from the normal delivery mode. For very high priority scores, additional communications such as notifications, which may be delivered via different communication channels, may be generated and delivered.

In a first embodiment, the inbox of a communication channel (e.g., email inbox or voicemail inbox) may be reordered automatically based on the priority generated by the W4 COMN. Thus, even though a sender may not consider a message to be important, the W4 COMN may generate a high priority score for the message based on the relationships between the recipient and the message, its topic, and its sender. This message, then, may be delivered as a high priority message and be automatically moved into a location in the inbox so that the recipient is made aware of immediately (e.g., the message is the first message in the inbox regardless of the other messages in the inbox and the relative times of their receipt by the inbox).

In a second embodiment, a high priority score may cause multiple different communications to be transmitted to the recipient via different RWEs associated with the recipient. For example, if a very high priority score, as determined based on a comparison with a predetermined threshold or range of priority scores, is generated for an email message, this message may be delivered not only to the recipient's email account but also the recipient may be notified of the message via an IM, text message or other communication sent to one or more devices such as a cell phone associated with the recipient. Alternatively, the message itself could be transmitted to all devices having known associations with the RWE by the W4 COMN.

In another embodiment, based on a priority score delivery of a communication may be delayed. For example, lower priority work-related emails transmitted during the weekend may not be delivered to a mobile device until Monday morning.

In an embodiment, recipients may also be able to control delivery by identifying one or more delivery actions to be performed based on a priority score or message delivery preferences. In another embodiment, recipients may be able to provide information directly to the prioritization engine for the purpose of changing the weighting of different W4 relationships. For example, a recipient may designate a sender as a high priority sender of certain types of communication (e.g., email, voice, voicemail, IM, etc.), thus indicating a delivery preference for that sender.

It should be noted that after delivery the data collection operation 812 will collect data associated with the delivered communication. This may occur before, during or after the actual prioritization operations are performed. In this way, the system may revise priority scores based on information contained within the communication being analyzed.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. Numerous other changes may be made that will readily suggest themselves to those skilled in the art and which are encompassed in the spirit of the invention disclosed and as defined in the appended claims.

What is claimed is:

1. A method for delivering messages comprising:
receiving a first message from a sender for delivery to a recipient;
retrieving user data associated with the sender and user data associated with the recipient;
generating a priority score for the first message based on a comparison of the sender's user data and recipient's user data; and
displaying a message listing to the recipient, the message listing identifying the first message and a plurality of previously-received second messages each having an associated priority score, wherein the message listing is ordered based on the priority score associated with each message.

2. The method of claim 1, wherein retrieving user data further comprises:
retrieving at least one of social data, spatial data, temporal data and logical data associated with each of the recipient and sender.

3. The method of claim 2, wherein generating a priority score further comprises:
determining a relationship between the sender and recipient based on the retrieved social data, spatial data, temporal data and logical data; and
generating the priority score for the first message based on the relationship.

4. The method of claim 2, wherein generating the priority score further comprises:
identifying a topic of the message;
identifying topic data in at least one of the sender's user data and recipient's user data, the topic data identifying topics of previous messages; and
generating the priority score for the first message based on the topic data.

5. The method of claim 4, wherein the topic data includes response times associated with the previous messages and generating a priority further comprises:
generating a priority score for the first message based on an average message response time for the previous messages associated with the topic.

6. The method of claim 4, wherein the topic data includes at least one event time for an event associated with the topic and generating a priority further comprises:
generating a priority score for the first message based on a comparison of the current time and the event time.

7. The method of claim 1 further comprising:
receiving at least one message delivery preference from the recipient or the sender; and
generating the priority score at least in part based on the message delivery preference.

8. The method of claim 1, wherein the first message is received via one of a plurality of different communication channels including at least two of a text message channel, an electronic mail channel, an instant message channel, a public switched telephone network channel, a voice over internet protocol channel, and the method further comprises:
generating the priority score for the first message at least in part based on the communication channel of the first message.

9. The method of claim 3, wherein determining a relationship includes at least one of comparing current contact attributes of the sender and the recipient;
comparing spatial data for each of the sender and recipient;
comparing past contact attributes of the sender and recipient;
retrieving at least one relationship previously selected by one of the sender or recipient; and
identifying previous messages between the sender and recipient.

10. The method of claim 1 further comprising:
collecting user data for a plurality of users including the sender and recipient;
for the recipient, generating a relative priority score for each user, each topic and each user-topic combination; and
generating the priority score for the first message based on the relative priority score of the sender, the relative priority score of the topic, and the relative priority score of the sender-topic combination.

11. The method of claim 10 further comprising:
revising the relative priority scores for the sender, the topic and the sender-topic combination based on the first message.

12. The method of claim 1 wherein displaying further comprising:
selecting a delivery time in the future for displaying of the message to the recipient based on the priority score.

13. The method of claim 1 wherein displaying further comprising:
selecting one or more of a plurality of different communication channels based on the priority score; and
delivering the message to the recipient via the selected one or more different communication channels.

14. A system that prioritizes communications comprising:
a correlation engine that retrieves data associated with information objects (IOs) transmitted between computing devices via at least one communication network;
computer-readable media connected to the correlation engine storing at least one of social data, spatial data, temporal data and logical data associated with a plurality of real-world entities (RWEs);
wherein the correlation engine, based on the detection of a first communication to be delivered to a first recipient via a first communication network, identifies one or more relationships between the first communication, the first recipient and the plurality of RWEs; and
a prioritization engine that generates a priority score for the communication based on the identified relationships; and
a delivery engine that delivers the communication to the first recipient based on the priority score.

15. The system of claim 14, wherein the communication is addressed to the first recipient and a second recipient different from the first recipient and the prioritization engine further generates a different probability score for each recipient based on that recipient's relationships with the first communication and the plurality of RWEs.

16. The system of claim 14, wherein the correlation engine identifies the topic of the communication and the priority score is generated at least in part based on a relationship between the first recipient and the topic determined from logical data associated with the first recipient.

17. The system of claim 14 further comprising:
an attribution engine that identifies a sender of the first communication as owner being one of the plurality of RWEs; and
the correlation engine identifies the sender of the communication and the priority score is generated at least in part based on a relationship between the first recipient and the sender determined from the social data for the sender and the other RWEs stored in the computer-readable media.

18. The system of claim 14, wherein the correlation engine identifies a physical location associated with the communication and the priority score is generated at least in part based on spatial data associated with the first recipient.

19. The system of claim 14, wherein the correlation engine identifies a future time associated with the first communication and the priority score is generated at least in part based on the current time and the temporal data associated with the first recipient.

20. The system of claim 14, wherein each relationship is assigned a weight and the priority score for the first communication is generated in part based on the relative weights of the relationships between the sender of the first communication, the first recipient of the communication, and the topic of the communication determined from the data for the RWEs stored in the computer-readable media.

21. The system of claim 20, wherein the social data, spatial data, temporal data and logical data associated with a plurality of RWEs are derived from the IOs transmitted over the at least one communication network.

22. A computer-readable medium encoding instructions for performing a method for prioritizing delivery of a communication to a recipient via a first communication channel, the method comprising:
dynamically identifying one or more relationships between the recipient and information known about the communication;
based on the identified relationships, generating a priority score for the communication; and
delivering the communication to the recipient via one of a plurality of delivery modes based on the priority score.

23. The computer-readable medium of claim 22, wherein the method further comprises:
retrieving one or more of social data, spatial data, temporal data and logical data associated with the recipient obtained from previous communications associated with the recipient received via a second communication channel; and
identifying one or more relationships between the recipient and information known about the communication based on the retrieved one or more of social data, spatial data, temporal data and logical data.

24. The computer-readable medium of claim 23, wherein the first and second communication channels are independently selected from an electronic mail message from one email account to another, a voicemail message transmitted via a telephone network, an instant message transmitted to a computing device, and a packet of data transmitted from one software application to another.

25. The computer-readable medium of claim 23, wherein the method further comprises:
identifying the topic of the communication based on contents of the communication; and
generating the priority score at least in part based on logical data associated with the recipient for prior communications having the topic delivered to the recipient via the first and second communication channel.
